(19) United States
(12) Patent Application Publication
(10) Pub. No.: US 2013/0101254 A1
(43) Pub. Date: Apr. 25, 2013

(54) OPTICAL PERFORMANCE MONITORING SYSTEM

(71) Applicants: Ming Cai, Fremont, CA (US); Christopher Lin, Washington, DC (US)

(72) Inventors: Ming Cai, Fremont, CA (US); Christopher Lin, Washington, DC (US)

(21) Appl. No.: 13/281,178

(22) Filed: Oct. 25, 2011

(51) Int. Cl. G02B 6/42

(52) U.S. Cl. 385/47

(57) ABSTRACT

An optical performance monitoring system includes a four-port tap coupling a tunable optical filter to a light detector. The four-port tap is configured as an optical tap and an optical splitter combined into a single optical element, where the optical tap directs a portion of an optical signal from an optical fiber to the tunable optical filter, and the optical splitter directs the optical signal from the tunable optical filter to the light detector. The optical performance monitoring system may employ tunable optical filters as a double-duty tunable filter or a double-pass tunable filter. As a double-duty tunable filter, optical signals to be monitored are passed through the tunable filter in opposite directions. As a double-pass tunable filter, a reflecting element is arranged on the output side of the tunable filter so that a filtered optical signal can be fed back into the tunable filter.

### BACKGROUND

Tunable optical filters are optical devices that perform optical filtering and can be tuned to select one or more narrow bands of wavelengths from a wider wavelength spectrum. They are used in a variety of optical systems, including wavelength division multiplexing (WDM) systems, in which information is carried by multiple channels, each channel having a unique wavelength. Other applications for tunable optical filters include optical noise filtering, noise suppression, wavelength division demultiplexing, and optical routing.

In WDM systems, basic system design assumes wavelength stability of the wavelength channels. However, a variety of dynamic changes occur due to temperature changes, component aging, electrical power variations, etc. For optimum system performance, it is necessary to monitor these changes and adjust system parameters to account for them. To accomplish this, optical channel monitors (OCMs), also known as optical performance monitors (OPMs), may be used to measure critical information for the various channels in the WDM system. OPMs may monitor signal dynamics, determine system functionality, identify performance change, etc. In each case OPMs typically provide feedback for controlling network elements to optimize operational performance. Specifically, these tunable optical filters scan the C-, L- and/or C+L-band wavelength range and precisely measure channel wavelength, power, and optical signal-to-noise ratio.

At the dense channel spacing found in WDM systems, e.g., 100 GHz, the filtering process requires tunable filters having very narrow bandwidth and high wavelength selectivity. Such optical filters are difficult and expensive to manufacture and/or must be impractically large. Consequently, as channel spacing in WDM systems continues to decrease, there is a need in the art for improving the performance of existing tunable optical filters.

### SUMMARY OF THE INVENTION

Embodiments of the invention provide an optical performance monitoring system that uses a four-port tap (also known as a 2×2 fiber optic coupler) to tap part of an optical signal propagating in a fiber optic transmission line, couple the tapped signal to a reflective tunable optical filter, and couple the reflected signal from the tunable filter to a light detector.

According to one embodiment of the invention, an optical performance monitoring system comprises a four-port tap, a light detector, and a tunable optical filter. The four-port tap has first, second, third and fourth ports for splitting an input optical signal received at the first port into a primary input optical signal output through the second port and a secondary input optical signal output through the third port, and for directing an optical signal received at the third port to be output primarily through the fourth port. The light detector is optically coupled to the fourth port of the four-port tap and the tunable optical filter is optically coupled to the third port of the four-port tap and configurable to select a channel to be monitored at the light detector from the secondary input optical signal.

According to another embodiment of the invention, an optical performance monitoring system comprises first and second four-port taps, a first light detector, a second light detector, and a tunable optical filter. Each of the first and second four-port taps has first, second, third and fourth ports for splitting an input optical signal received at the first port into a primary input optical signal output through the second port and a secondary input optical signal output through the third port, and for directing an optical signal received at the third port to be output primarily through the fourth port. The first light detector is optically coupled to the fourth port of the first four-port tap and the second light detector is optically coupled to the fourth port of the second four-port tap. The tunable optical filter is optically coupled to each of the third ports of the four-port taps and is configurable to select a channel or other spectral portion of the total optical signal to be monitored at the first and second light detectors from each of the secondary input optical signals received from the four-port taps.

A WDM system according to an embodiment of the invention includes a multiplexer optically coupled to a plurality of wavelength channels and configured to generate a WDM signal therefrom, a four-port tap having a first port by which the WDM signal is received, and second, third, and fourth ports, wherein the four-port tap splits the WDM signal into a primary WDM signal that is transmitted through the second port and a tap signal that is transmitted through the third port, a light detector optically coupled to the fourth port of the four-port tap, and a tunable optical filter optically coupled to the third port of the four-port tap and configurable to select a channel to be monitored at the light detector from the tap signal. The channel to be monitored as selected by the tunable optical filter is supplied to the third port of the four-port tap, passes through the four-port tap, and is transmitted through the fourth port of the four-port tap.

### BRIEF DESCRIPTION OF THE DRAWING

FIG. 1 schematically illustrates a portion of a wavelength division multiplexing (WDM) system that includes an optical performance monitor (OPM) configured according to an embodiment of the invention.

FIG. 2 schematically illustrates an OPM, according to one embodiment of the invention.

FIG. 3 schematically illustrates an OPM having an optical circulator as a reflecting element, according to one embodiment of the invention.

FIG. 4 schematically illustrates an OPM configured as a double-duty filter, according to an embodiment of the invention.

### DETAILED DESCRIPTION

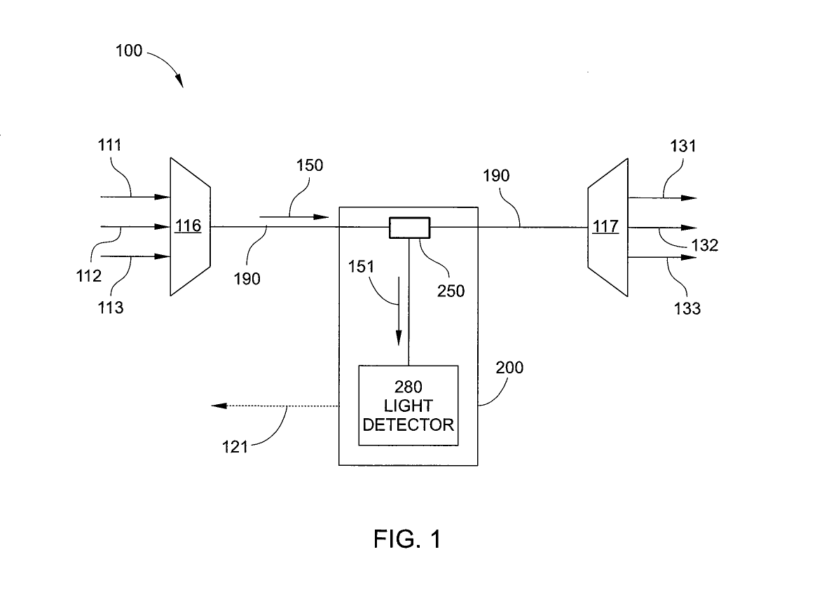

FIG. 1 schematically illustrates a portion of a wavelength division multiplexing (WDM) system 100 that includes an optical performance monitor (OPM) 200 configured according to an embodiment of the invention. WDM system 100 further includes a multiplexer 116, a demultiplexer 117, and a transmission line 190 connecting multiplexer 116 and demultiplexer 117. For simplicity, WDM system 100 is depicted with three wavelength channels 111, 112, and 113 entering multiplexer 116 and three corresponding wavelength channels 131, 132, and 133 exiting demultiplexer 117. In practice, however, typical WDM systems may have many more wavelength channels, e.g., 50-100 or more.

In operation, wavelength channels 111, 112, and 113 are multiplexed by multiplexer 116 and are transmitted over transmission line 190 as a WDM signal 150. WDM signal 150 is received and demultiplexed into individual wavelength channels 131, 132, and 133 by demultiplexer 117. OPM 200 is configured to tap a sample signal 151 from WDM signal 150 using a four-port tap 250 and monitor one or more of wavelength channels 111-113 using a light detector 280 as said channels are being transmitted via transmission line 190. Monitoring results are fed back to the transmission hardware for wavelength channels 111-113 via feedback loop 121 for adjusting signal parameters to correct errors detected by OPM 200.

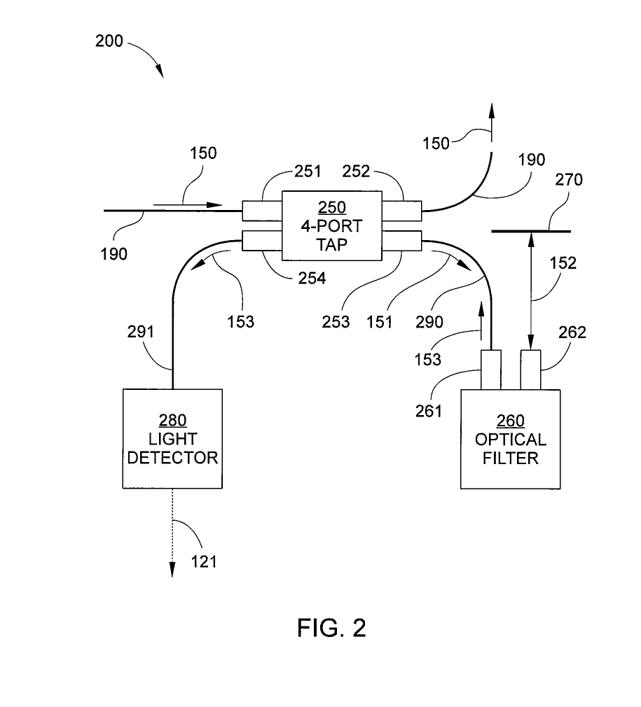

FIG. 2 schematically illustrates OPM 200, according to one embodiment of the invention. As shown, OPM 200 includes the four-port tap 250, a tunable optical filter 260, a reflecting element 270, and the light detector 280. OPM 250 is optically coupled to transmission line 190 via four-port tap 250, and is configured so that sample signal 151 undergoes a “double pass” through tunable optical filter 260 before being directed to light detector 280 for analysis. As is described in greater detail below, four-port tap 250 is a single optical element that acts as both an optical tap from transmission line 190 and an optical splitter that facilitates the double-pass configuration of tunable optical filter 260.

Four-port tap 250 is a four-port tap or a 2×2 optical coupler, commonly known in the art. Four-port tap 250 may be constructed by fusing or otherwise joining two optical fibers lengthwise to bring the cores of the fibers in close proximity so as to induce optical coupling from one of the optical fibers to the other, where the degree of coupling between the two fibers may be fixed at any desired value. Because the magnitude of sample signal 151 can be relatively small compared to the magnitude of WDM signal 150, the coupling between the two fibers making up four-port tap 250 is generally weak. For example, in one embodiment, the coupling between the two fibers making up four-port tap 250 is 10% or less, and the magnitude of sample signal 151 relative to the magnitude of WDM signal 150 is proportionate to said coupling. In another embodiment, the coupling between the two fibers making up four-port tap 250 is on the order of about 2%, and consequently the magnitude of sample signal 151 is about 2% that of WDM signal 150. In other embodiments, sample signal 151 may include all of WDM signal 150, or one or more of wavelength channels 111-113, and may be a modulated or unmodulated optical signal. Further, the portion of the signal tapped to implement an OPM function may vary widely, depending on application. In WDM applications, sample signal 151 is typically less than 10% of WDM signal 150. However, a variety of OPM arrangements may be used for monitoring WDM signal 150, including interrupting WDM signal 150 and routing WDM signal 150 in its entirety to light detector 280. In some embodiments, multiple light detectors may also be used to monitor larger, smaller, or different portions of WDM signal 150.

Four-port tap 250 is configured with four ports. In the embodiment illustrated in FIG. 2, four-port tap 250 has an input port 251, two output ports 252, 254, and an input/output port 253, however, the 4 ports of four-port tap 250 may be employed in other configurations and fall within the scope of the invention. To wit, each of said ports may be an input port, an output port, or a combined input/output port. In FIG. 2, transmission line 190 is coupled to input port 251 and to output port 252. Also, a fiber section 290 couples tunable optical filter 260 to input/output port 253, and a fiber section 291 couples light detector 280 to output port 254. Thus, in an embodiment in which four-port tap 250 is configured to tap a sample signal 151 having a magnitude that is 2% that of WDM signal 150, 98% of WDM signal 150 is directed from input port 251 to output port 252 and 2% of WDM signal 150, i.e., sample signal 151, is directed from input port 251 to input/output port 253 and is coupled to fiber section 290. In such an embodiment of four-port tap 250, an optical signal entering input/output port 253 also undergoes a 1×2 split, in which 98% of the optical signal is directed to output port 254 and 2% of the optical signal is directed to input port 251. The coupling of such a weak signal from the optical fiber back into the input port is generally not problematic as long as it is sufficiently weak. This favors the use of four-port taps with weak coupling ratios, e.g., <10% and, more preferably, <2%. Due to the bidirectional functionality of four-port tap 250, other 1×2 splits can also occur. For example, if an optical signal were to enter output port 252, 98% of the optical signal would be directed out of input port 251 and 2% of the optical signal would be directed to output port 254.

Tunable optical filter 260 is configured to select one of wavelength channels 111-113, or some other small fraction of the optical spectrum, to be monitored at light detector 280, the latter measuring the power spectrum of the selected wavelength channel. Thus, as tunable optical filter 260 sweeps across all wavelength channels 111-113 in WDM signal 150, power changes in each of wavelength channels 111-113 multiplexed into WDM signal 150 can be selectively detected. Tunable optical filter 260 can be any technically feasible optical filter that is configured as a 2-port reciprocal device, i.e., any tunable optical filter in which the input and the output are interchangeable, and can be tuned over a useful wavelength range, e.g, on the order of 10's of nm. In some embodiments, tunable optical filter 260 is configured to filter an input optical band of, for example, 1550 nm to 1580 nm, so that channels within that optical band can be selected and directed to light detector 280. Tuning may be effected by changing an electrical operating parameter of the tunable optical filter (e.g. voltage or current), by mechanically changing the physical structure of the device, by heating or cooling the device, etc. Devices suitable for use as tunable optical filter 260 include thin-film interference filters, an example of which is described in U.S. Pat. No. 6,713,743. Alternatively, a MEMS-based filter may also be suitable for use as tunable optical filter 260, an example of which is described in U.S. Pat. No. 6,373,632. Other reciprocal tunable optical filters known in the art may also be used.

As shown, tunable optical filter 260 includes a first port 261 and a second port 262. According to embodiments, of the invention, second port 262 can be configured as an optical input/output port for tunable optical filter 260. Because tunable optical filter 260 is an optically reciprocal device, when tunable optical filter 260 is optically coupled to reflecting element reflecting element 270 via second port 262, tunable optical filter 260 can be used as a double-pass filter. The operation of tunable optical filter 260 as a double-pass filter is described in greater detail below.

Reflecting element 270 is optically coupled to second port 260 of tunable optical filter 260 and is configured to direct an optical signal exiting second port 262 back to second port 262 of tunable optical filter, so that said signal undergoes a second pass through tunable optical filter 260. Reflecting element 270 can be any technically feasible light-reflecting element or elements suitable for directing an optical signal from second port 262 back to second port 262, such as a mirror, an optical circulator, and the like. Reflecting element 270 is optically coupled to second port 262 via a physical coupling or through free space. A physical coupling may include an optical fiber, a waveguide, and the like. When reflecting element 270 is optically coupled to second port 262 through free space, reflecting element 270 may include one or more mirrors, lenses, or other optical elements configured to optically align the output of second port 262 with reflecting element 270. In embodiments in which reflecting element 270 is an optical circulator, reflecting element 270 is preferably coupled to and from the output port of the tunable optical coupler by one or more optical fiber links.

Light detector 280 is configured to measure the power spectrum of an optical signal directed from tunable optical filter 260. Light detector 280 can be any technically feasible device for measuring the power of incident light, such as a photodiode. One of skill in the art will recognize that some tunable optical filter designs known in the art include a photodetector element integrated with a tunable optical filter. Such designs physically restrict access to the tunable optical filter in such a way as to prevent a convenient means for providing a double pass through the tunable optical filter, as described above. In most such cases, it is only necessary to disintegrate the tunable optical filter and the photodetector and replace the photodetector with a reflective element in order to implement an embodiment of the invention as described herein.

In operation, OPM 200 is configured to tap a sample signal 151 from WDM signal 150 and monitor one or more of wavelength channels 111-113 as said channels are being transmitted via transmission line 190. Specifically, four-port tap 250 taps a portion of WDM signal 150, i.e., sample signal 151, from transmission line 190, and directs the remainder portion of WDM signal 150 to output port 252 and the downstream segment of transmission line 190. Thus, four-port tap 250 acts as a 1×2 optical splitter. Four-port tap 250 directs sample signal 151 to input/output port 253, which is coupled to fiber section 290. As noted above, in some embodiments, a relatively small portion of WDM signal 150 is tapped from transmission line 190 to produce sample signal 151, for example approximately 2%.

Sample signal 151 is received by tunable optical filter 260 at first port 261, is filtered a first time by tunable optical filter 260, and exits second port 262 as partially filtered signal 152. Partially filtered signal 152 is directed back to tunable optical filter 260 by reflecting element 270, is filtered a second time by tunable optical filter 260, and exits first port 261 as filtered signal 153. As shown, filtered signal 153 is directed to input/output port 253 of four-port tap 250 by fiber section 290, and is then routed to light detector 280 by four-port tap 250 for power measurement. Power monitoring results are fed back to WDM transmitter 160 in FIG. 1 via feedback loop 121 for adjusting signal parameters to correct errors detected by OPM 200.

At any one moment, filtered signal 153 generally consists of a single wavelength channel of interest from WDM signal 150, and is selected by the passband of tunable optical filter 260. At dense channel spacing, e.g., 100 GHz, 50 GHz, or smaller, the filtering process requires very narrow tunable filters, which are difficult and expensive to manufacture. Because double-pass filtering is used by OPM 200, tunable optical filter 260 has the performance of a much narrower filter. Specifically, the bandwidth of the light from double-pass filtering is narrower than that of light that undergoes a single pass with the same filter. Additional performance parameters of an optical filter that are improved by double-pass filtering include adjacent and non-adjacent channel isolation, dynamic range, and differential dynamic range. Adjacent channel isolation is the difference between the minimum point in the pass channel and the maximum point in the adjacent channels over all relevant polarization states and over the temperature range of the specification; non-adjacent channel isolation is the difference between the minimum point in the pass channel and the maximum point of non-adjacent channels; and differential dynamic range is the extent to which channels of different power levels may be distinguished. Thus, by using tunable optical filter 260 as a double-pass filter, the performance of tunable optical filter 260 is greatly improved. Consequently, a lower-performance tunable optical filter may be used in OPM 200 to effectively monitor narrow-band WDM signals.

A further advantage of OPM 200 is that optical performance monitoring of WDM channels 111-113 can be carried out with significantly improved optical loss performance. Specifically, four-port tap 250 serves as both an optical tap from transmission line 190 and as an optical element for directing filtered signal 153 to light detector 280. Consequently, OPM 200 requires fewer optical elements than prior art optical performance monitors, thereby reducing optical losses. For example, an optical tap of some sort is required to extract a sample optical signal for optical performance monitoring, and this generally introduces an optical loss on the order of about 3 dB in the sampled optical signal. To enable double-pass filtering, one or more additional optical elements are needed to direct the sampled optical signal through a tunable optical filter twice and then to direct the filtered sample signal to a light detector. Each of these additional optical elements, such as optical circulators and the like, introduce significant optical losses in the sampled optical signal, e.g., on the order of 3 dB. Because these additional functions are also performed in OPM 200 by four-port tap 250, OPM 200 can perform the desired optical performance monitoring of WDM channels 111-113 with optical losses reduced by 3 dB or more.

Thus, embodiments of the invention provide an optical performance monitoring system that has fewer optical elements, improved loss performance, and improved performance parameters. Consequently, prior art tunable optical filters may be improved according to the invention by designing the optical system architecture to provide a double pass of the signal being analyzed through the tunable optical filter. The invention may be implemented with any tunable optical filter which is reciprocal, which includes most types of known tunable optical filters.

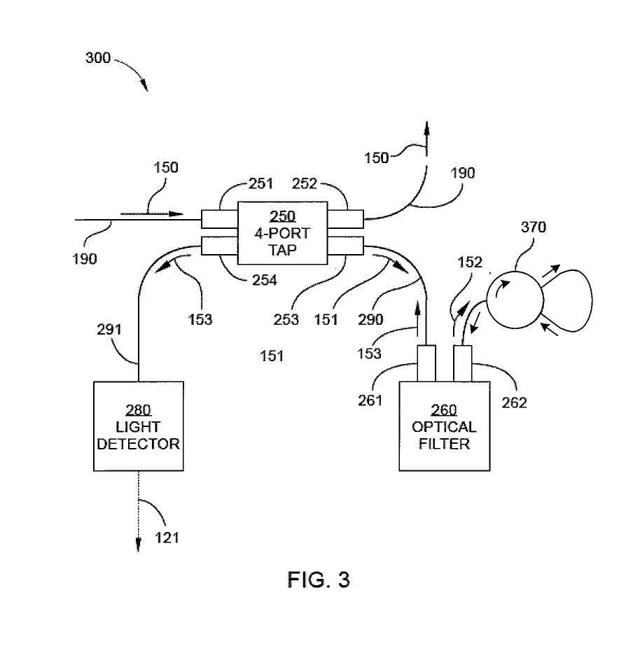

As noted above, reflecting element 270 may include an optical circulator. FIG. 3 schematically illustrates an OPM 300 having an optical circulator 370 as a reflecting element, according to one embodiment of the invention. Because of the low insertion loss associated with optical circulators, the use of optical circulator 370 in lieu of a mirror does not add significant optical loss to OPM 300.

According to embodiments of the invention, the use of a four-port tap as a combined optical tap and signal routing element may be extended to a “double-duty” filter, in which a single tunable optical filter is used for two separate input signals. In such an embodiment, the double-duty configuration effectively doubles the number of transmission lines that can be monitored by an OPM, while the use of four-port taps as combined optical taps and signal routing elements reduces optical losses in the OPM.

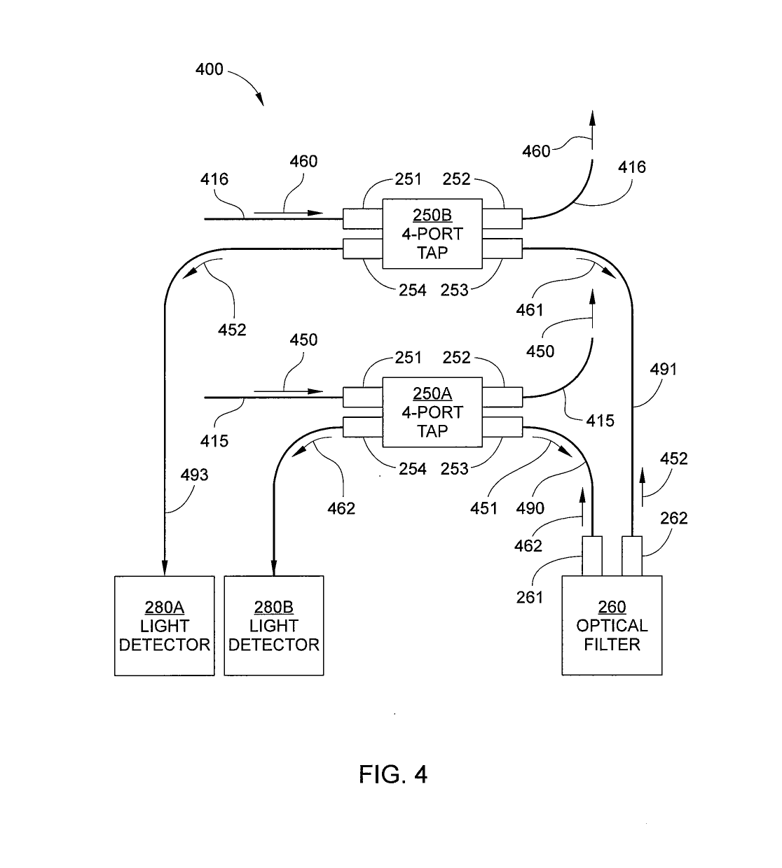

FIG. 4 schematically illustrates an OPM 400 configured as a double-duty filter, according to an embodiment of the invention. OPM 400 is similar in organization and operation to OPM 200, except that OPM 400 is configured for monitoring wavelength channels from two separate transmission lines 415, 416 with single-pass filtering rather than a single wavelength channel with double-pass filtering. Consequently, OPM 400 includes two four-port taps 250A, 250B, two light detectors 280A, 280B, and a single tunable optical filter 260, configured as shown.

In operation, OPM 400 monitors one or more wavelength channels from WDM signal 450 in transmission line 415 by extracting a sample signal 451 using four-port tap 250A. Fiber section 490 optically couples four-port tap 250A to tunable optical filter 260 and directs sample signal 451 to first port 261 of tunable optical filter 260. Sample signal 451 undergoes single-pass filtering by tunable optical filter 260 and exits second port 262 as filtered signal 452. Fiber section 491 directs filtered signal 452 to four-port tap 250B, and four-port tap 250B directs filtered signal 452 to light detector 280A for power monitoring via sample fiber 493. In a parallel fashion, a sample signal 461 from a sample signal 460 in transmission line 416 is directed to second port 262 of tunable optical filter 260 via sample fiber 491, undergoes single-pass filtering by tunable optical filter 260, and exits first port 261 as filtered signal 462. Filtered signal 462 is then directed to light detector 280B by four-port tap 250A as shown. Thus, tunable optical filter 260 can be used for monitoring two transmission lines, thereby doubling the cost-effectiveness of tunable optical filter 260. In addition, optical losses in OPM 400 are reduced over OPM configurations in which separate optical elements are used to perform the functions of optically tapping transmission lines 415, 416 and directing filtered signals 452, 462 to light detectors 280A, 280B, respectively.

Embodiments of the invention describe the use of four-port taps for facilitating double-pass and double-duty filtering in WDM systems. In other embodiments, tunable optical filters coupled to a four-port tap may be used in other applications involving OPM, such as correction of wavelength drift, etc. Furthermore, while embodiments of the invention described herein are disclosed using optical fiber assemblies and components, other forms of waveguides may also be used. For example, an optical integrated circuit may be used to route one or more optical signals through a tunable optical filter.

While the foregoing is directed to embodiments of the present invention, other and further embodiments of the invention may be devised without departing from the basic scope thereof, and the scope thereof is determined by the claims that follow.

We claim:

1. An optical performance monitoring system, comprising:
a four-port tap having first, second, third and fourth ports, for splitting an input optical signal received at the first port into a primary input optical signal output through the second port and a secondary input optical signal output through the third port, and for directing an optical signal received at the third port to be output primarily through the fourth port;
a reflective tunable optical filter optically coupled to the third port of the four-port tap and configurable to reflect a portion of the input optical signal to be monitored back to the third port of the four-port tap; and
a light detector optically coupled to the fourth port of the four-port tap.

2. The optical performance monitoring system of claim 1, wherein the reflective tunable optical filter comprises a transmissive tunable optical filter with a reflecting element positioned at an output port thereof to direct an optical signal output from the tunable optical filter back into the tunable optical filter.

3. The optical performance monitoring system of claim 2, wherein the reflecting element is a mirror.

4. The optical performance monitoring system of claim 2, wherein the reflecting element is an optical circulator.

5. The optical performance monitoring system of claim 1, wherein the reflective tunable optical filter is configurable to select the portion of the input optical signal to be monitored.

6. The optical performance monitoring system of claim 6, wherein the portion of the input optical signal to be monitored is a wavelength channel contained in the input optical signal.

7. An optical performance monitoring system, comprising:
first and second four-port taps each having first, second, third and fourth ports, for splitting an input optical signal received at the first port into a primary input optical signal output through the second port and a secondary input optical signal output through the third port, and for directing an optical signal received at the third port to be output primarily through the fourth port;
a first light detector optically coupled to the fourth port of the first four-port tap; and
a second light detector optically coupled to the fourth port of the second four-port tap; and
a tunable optical filter optically coupled to each of the third ports of the four-port taps and configurable to select a portion of the input optical signal to be monitored at the first and second light detectors from each of the secondary input optical signals received from the four-port taps.

8. The optical performance monitoring system of claim 7, wherein the tunable optical filter has a first port optically coupled to the third port of the first four-port tap and a second port optically coupled to the third port of the second four-port tap.

9. The optical performance monitoring system of claim 8, wherein the portion of the input optical signal to be monitored at the first light detector and the portion of the input optical signal to be monitored at the second light detector have the same characteristic wavelengths.

10. The optical performance monitoring system of claim 7, wherein tunable optical filter is configurable to select the portion of the input optical signal to be monitored at the first and second light detectors.

11. A wavelength division multiplexing (WDM) system, comprising:
a multiplexer optically coupled to a plurality of wavelength channels and configured to generate a WDM signal therefrom;
a four-port tap having a first port by which the WDM signal is received, and second, third, and fourth ports, wherein the four-port tap splits the WDM signal into a primary WDM signal that is transmitted through the second port and a tap signal that is transmitted through the third port;
a reflective tunable optical filter optically coupled to the third port of the four-port tap and configurable to reflect a spectral portion of the WDM signal to be monitored back to the third port of the four-port tap; and
a light detector optically coupled to the fourth port of the four-port tap.

12. The WDM system of claim 11, wherein the reflective tunable optical filter comprises a transmissive tunable optical filter with a reflecting element positioned at an output port thereof to direct an optical signal output from the tunable optical filter back into the tunable optical filter.

13. The WDM system of claim 12, wherein the reflecting element is a mirror.

14. The WDM system of claim 12, wherein the reflecting element is an optical circulator.

15. The WDM system of claim 11, wherein the reflective tunable optical filter is configurable to select the spectral portion of the WDM signal to be monitored.

16. The WDM system of claim 15, wherein the spectral portion of the WDM signal to be monitored is a wavelength channel contained in the WDM signal.
